(19) United States
(12) Patent Application Publication
(10) Pub. No.: US 2007/0071191 A1
(43) Pub. Date: Mar. 29, 2007

(54) Server apparatus

(75) Inventors: Yasumasa Sasaki, Tachikawa-shi (JP); Shigeru Fukazawa, Hachioji-shi (JP); Koji Shima, Sagamihara-shi (JP); Fumikazu Matsukawa, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/475,399

(22) Filed: Jun. 26, 2006

(30) Foreign Application Priority Data
Jun. 30, 2005 (JP) 2005-192671

(51) Int. Cl. H04M 11/00

(52) U.S. Cl. 379/93.09

(57) ABSTRACT

According to one embodiment, a server apparatus includes a memory which stores a management table indicating a correspondence relation between the terminal IDs and the connection IDs contained in a call information event and state information representing a call connection state between the plurality of telephone terminals, when the call connection is established between the plurality of telephone terminals, a determination unit to determine whether a call connection state between telephone terminals corresponding to the connection IDs is changed by referring to the management table based on the connection IDs contained in the call information event, when the call information event is received, and a controller which updates state information corresponding to the connection IDs in the management table, and performs a data communication connection between data terminals associated with the terminal IDs of the plurality of telephone terminals to be connected, based on the updated status information.

### CROSS-REFERENCE TO RELATED APPLICATIONS

This application is based upon and claims the benefit of priority from Japanese Patent Application No. 2005-192671, filed Jun. 30, 2005, the entire contents of which are incorporated herein by reference.

### BACKGROUND

1. Field

One embodiment of the invention relates to a server apparatus of a visual communication system, which is connected to a plurality of telephone exchanges connected to each other through a dedicated line, through a communication channel to process video signals and computer data as well as speech signals.

2. Description of the Related Art

An in-house network system is used in offices and places of business. In the system, a telephone exchange such as a private branch exchange (PBX) and a button telephone has telephones as extension terminals. The exchange connection of the telephone exchange allows a call between the extension terminals and an external communication network such as a public network and between the extension terminals. In the system, further, information terminals such as personal computers are connected to a computer network to transfer data between the information terminals via the computer network (for example, See Jpn. Pat. Appln. KOKOKU Publication No. 8-1628).

The above in-house network system includes a communication-type subnetwork management system and a computer-type subnetwork management system both using a telephone exchange. The study for managing these systems using information common to the systems is in progress.

A visual communication system has conventionally been desired in which a telephone and an information terminal are associated with each other to carry out video communication in accordance with an operation of the telephone. Under present circumstances, however, the visual communication system is being considered and has not yet been achieved.

In order to achieve the above visual communication system, the following problem has to be resolved.

There is a service that cannot be offered by a multinode system in which telephone exchanges are connected through a dedicated line.

For example, there is a call service for a three-party conference in which a telephone terminal at a node (telephone exchange) interrupts a two-party call at another node. If information of the two-party call is stored in an in-terminal connection management database and no other-end-party information is present in an event at the time of the interrupt, the user of the telephone terminal cannot specify what connection the user interrupts even by the use of a call number of each of the nodes as association information. The three parties whose telephone terminals are in use cannot be specified; therefore, no visual communication can be performed among the three parties.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram of a visual communication system according to a first embodiment of the present invention;

FIG. 2 is a block diagram of a functional structure of a VCS server in the visual communication system according to the first embodiment of the present invention;

FIG. 3 is a diagram showing an example of contents stored in a connection information management table shown in FIG. 2;

FIG. 4 is a diagram showing an example of contents stored in an extension terminal and visual client (VC) association table shown in FIG. 2;

FIG. 5 is a diagram showing an example of contents stored in a session information management shown in FIG. 2;

FIG. 6 is a schematic sequence chart showing transmission and reception of information between extension terminals, main devices, a VCS server and data terminals when visual communication is carried out in the visual communication system according to the first embodiment of the present invention;

FIG. 7 is a flowchart showing a procedure for controlling the VCS server when visual communication is carried out in the visual communication system according to the first embodiment of the present invention;

FIG. 8 is a sequence chart illustrating an example of a third party's interrupt call in the visual communication system according to the first embodiment of the present invention; and

FIG. 9 is a sequence chart illustrating an operation of a conference call according to a second embodiment of the present invention.

### DETAILED DESCRIPTION

Various embodiments according to the invention will be described hereinafter with reference to the accompanying drawings. In general, according to one embodiment of the invention, a server apparatus which receives call information including terminal IDs and connection IDs specifying a plurality of telephone terminals to perform call connections by a telephone exchange apparatus executing exchange processing among a plurality of telephone terminals, and which links data communication connections at data terminals associated with the plurality of the telephone terminals, respectively, with the call connections, the server apparatus comprising: a memory which stores a management table indicating a correspondence relation between the terminal IDs and the connection IDs contained in a call information event from the telephone exchange apparatus and state information representing a call connection state between the plurality of telephone terminals, when the call connection is established between the plurality of telephone terminals; a determination unit to determine whether a call connection state between telephone terminals corresponding to the connection IDs is changed by referring to the management table based on the connection IDs contained in the call information event, when the call information event is received; and a controller which updates state information corresponding to the connection IDs in the management table, when the determination unit determines that the call connection state is changed, and performs a data communication connection between data terminals associated with the terminal IDs of the plurality of telephone terminals to be connected, based on the updated status information.

### First Embodiment

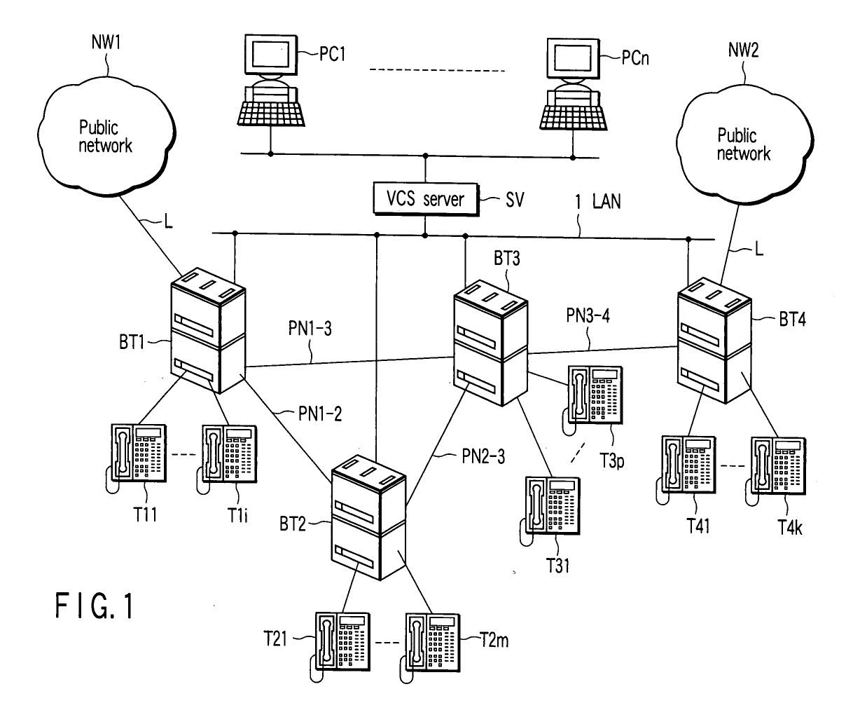

FIG. 1 is a schematic diagram of a visual communication system according to a first embodiment of the present invention.

As shown in FIG. 1, the visual communication system includes main devices BT1, BT2, BT3 and BT4 that are connected to each other through a dedicated line PN (PN1-2, PN1-3, PN2-3, PN3-4). The main devices BT1, BT2, BT3 and BT4 have extension terminals Tll to Tli, T21 to T2m, T31 to T3p and T41 to T4k via extensions. The main devices BT1 and BT4 are connected to public networks NW1 and NW2 through local lines L.

The main devices BT1, BT2, BT3 and BT4 are connected to a local area network (LAN) 1. A visual communication system (VCS) server SV is connected to the LAN 1. The VCS server SV has a plurality of data terminals PCl to PCn. The data terminals PC1 to PCn are each configured by a general-purpose personal computer and associated with the extension terminals T11 to T1i, T21 to T2m, T31 to T3p and T41 to T4k.

The VCS server SV carries out additional functions for the main devices BT1, BT2, BT3 and BT4. It processes media information such as image data.

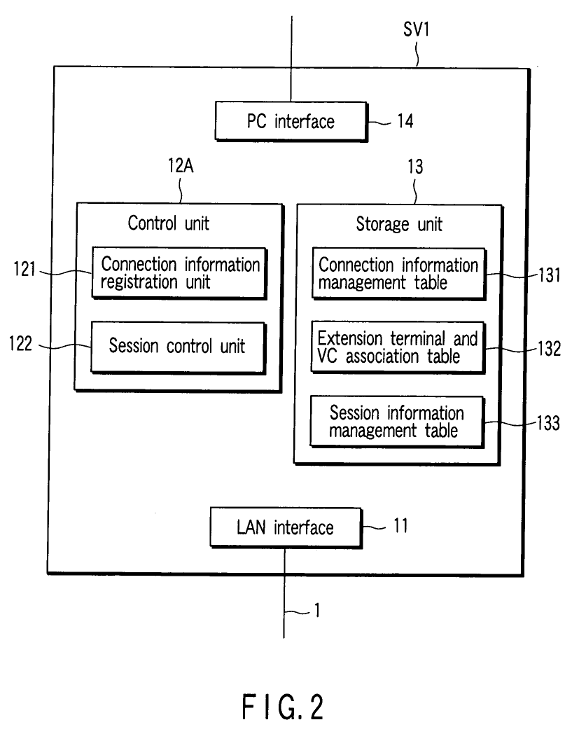

FIG. 2 is a block diagram of a functional structure of the VCS server SV described above.

The VCS server SV includes a LAN interface unit 11, a control unit 12, a storage unit 13 and a PC interface unit 14. The LAN interface unit 11 interfaces with the LAN 1.

The PC interface unit 14 interfaces with the data terminals PC1 to PCn.

The storage unit 13 stores routing information necessary for connection control of the control unit 12. The storage unit 13 has a connection information management table 131 (referred to as table 131 hereinafter), an extension terminal and visual client (VC) association table 132 (referred to as table 132 hereinafter) and a session information management table 133 (referred to as table 133 hereinafter).

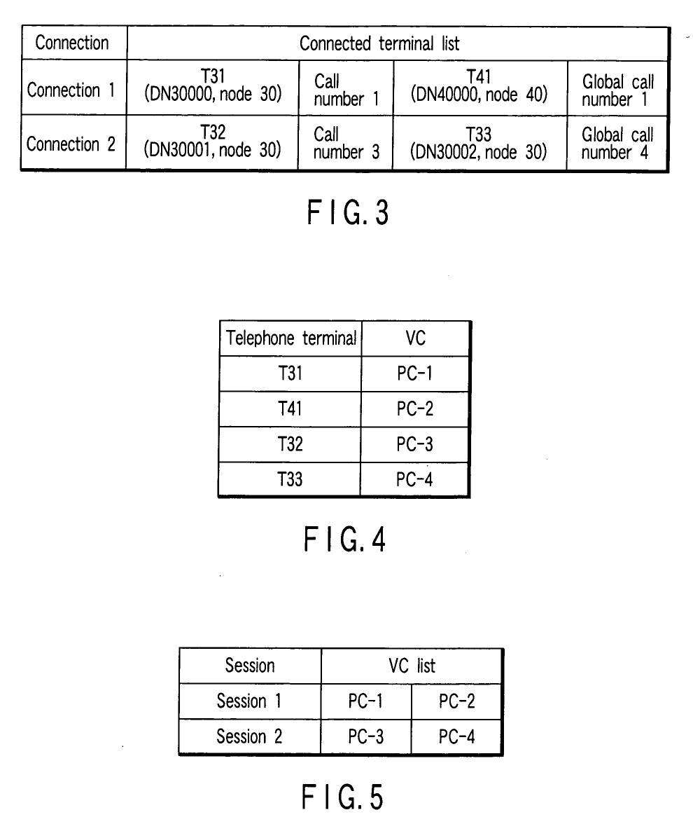

As shown in FIG. 3, the table 131 stores data representing a correspondence between device information (DN, node ID) of each of the extension terminals T11 to T1i, T21 to T2m, T31 to T3p and T41 to T4k, global call numbers indicative of connection ID for specifying the extension terminals T11 to T1i, T21 to T2m, T31 to T3p and T41 to T4k to be connected, and state information indicative of a connection state.

As shown in FIG. 4, the table 132 stores data representing a correspondence between the extension terminals (telephone terminals) T11 to T1i, T21 to T2m, T31 to T3p and T41 to T4k and the data terminals (VC) PC1 to PCn. Hereinafter, the first embodiment will be described using extension terminals T31, T32, T33 and T41 as exemplary ones of the extension terminals and data terminals PC1, PC2, PC3 and PC4 as exemplary ones of the data terminals. When the data terminals PC1, PC2, PC3 and PC4 are connected to the VCS server SV, they notify the VCS server SV of extension numbers for associating the data terminals with the extension terminals. The VCS server SV updates the contents stored in the table 132 in accordance with the extension numbers.

As shown in FIG. 5, the table 133 stores information representing a session between the data terminals PC1, PC2, PC3 and PC4.

The control unit 12 includes a connection information registration unit 121 and a session control unit 122 as new functions in addition to a control function related to the state management of the data terminals PC1, PC2, PC3 and PC4 and the association between the data terminals PC1, PC2, PC3 and PC4 and the extension terminals T31, T32, T33 and T41.

The connection information registration unit 121 analyzes a call information event transmitted from the main device BT3 to determine that a call is in progress between, e.g., the extension terminals T31 and T41 and update information of “connection 1” of the table 131 additionally.

The session control unit 122 updates the connection information “connection 1” of the table 131 to “three-party connection” when it receives a call information event, which indicates an interrupt call of the extension terminal T32 in the extension terminal T31, from the main device BT3 while a call is in progress between, e.g., the extension terminals T31 and T41. On the basis of the updated connection information, the session control unit 122 reads from the table 132 the fact that the extension terminal T31 is associated with the data terminal PC1, the extension terminal T41 is associated with the data terminal PC2, and the extension terminal T32 is associated with the data terminal PC3, and searches the table 133 for a session between the data terminals PC1, PC2 and PC3 to control the session. Since no session is established between the data terminals PC1 and PC2 when they start to call each other, the session control unit 122 controls the data terminals PC1 and PC2 to start a session therebetween. When the session is established, the unit 122 updates the contents stored in the table 133.

An operation of the visual communication system so configured will be described below.

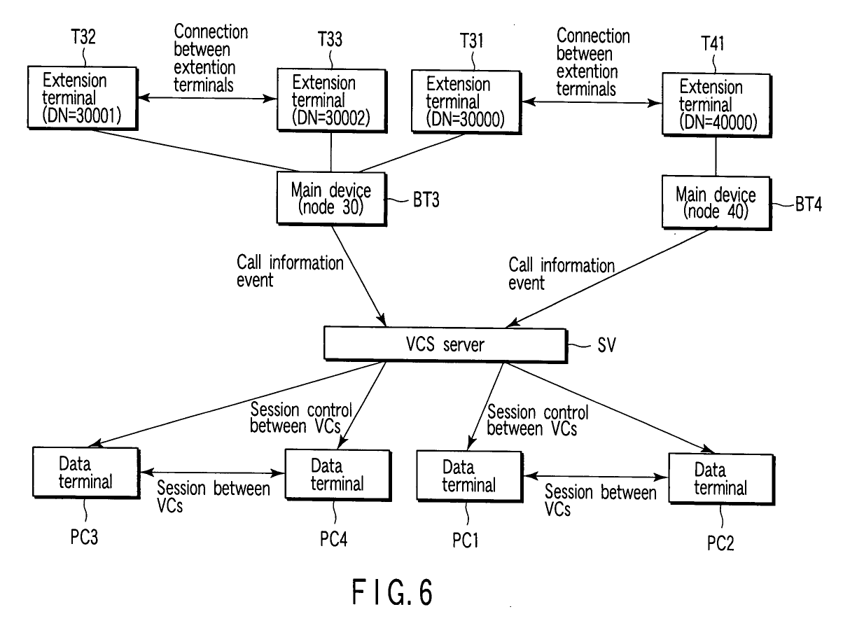

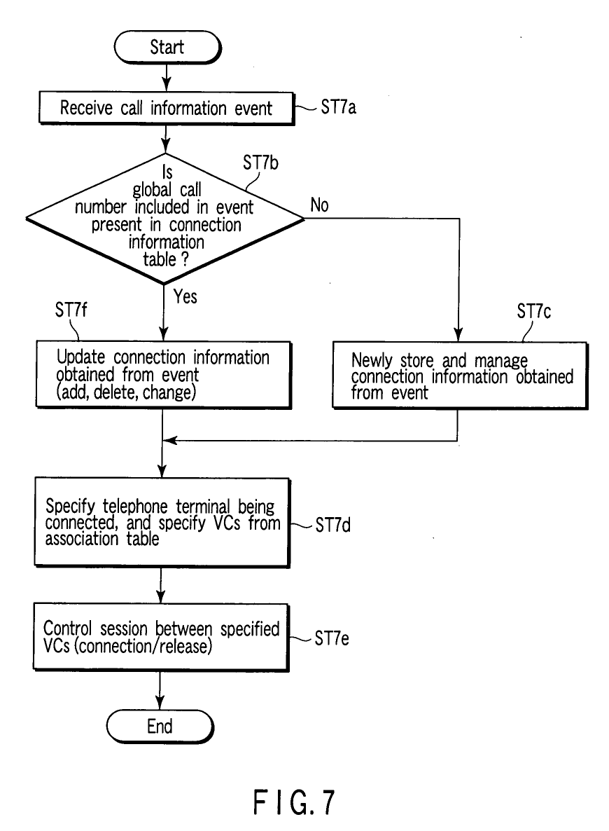

FIG. 6 is a schematic sequence chart showing transmission and reception of information between the extension terminals T31, T32, T33 and T41, main devices BT3 and BT4, VCS server SV and data terminals PC1, PC2, PC3 and PC4 when visual communication is carried out. FIG. 7 is a flowchart showing a procedure for controlling the VCS server SV when the visual communication is carried out.

(Call from Extension Terminal T31 to Extension Terminal T41)

Assume that a user of the extension terminal T31 dials “4040000” to call a user of the extension terminal T41. The extension terminal T31 transmits a communication establishment request signal to the main device BT3. Upon receiving the signal, the main device BT3 transfers the signal to the main device BT4 via an IP dedicated line PN3-4. Then, the main device BT4 calls the extension terminal T41. The extension terminal T41 replies to the main device BT4 and establishes a communication link with the extension terminal T31.

Consequently, the user of the extension terminal T31 can communicate with the user of the extension terminal T41.

The VCS server SV receives a call information event from the main device BT4 at the incoming node (block ST7a) and determines whether a global call number included in the call information event is present in the table 131 (block ST7b).

It is here determined that no global call number is present because the call has started. The VCS server SV stores in the table 131 the connection information “connection 1” obtained from the call information event and the outgoing device information (DN, node ID, global call number) and incoming device information (DN, node ID, global call number) in correspondence with each other (block ST7c).

Based on the connection information “connection 1,” the VCS server SV reads the correspondence between the extension terminal T31 and data terminal PC1 and the correspondence between the extension terminal T41 and data terminal PC2 from the table 132 (block ST7d) and searches the table 133 for a session between the data terminals PC1 and PC2.

Since the call starts here, the VCS server controls the data terminals PC1 and PC2 to start a session therebetween (block ST7e). When the session is established, the VCS server SV updates the contents stored in the table 133.

Consequently, the user of the extension terminal T31 can automatically start video communication between the extension terminal T31 and the data terminal PC2 using the data terminal PC1 only by operating the extension terminal T31.

(Interrupt Call of Third Party during Call)

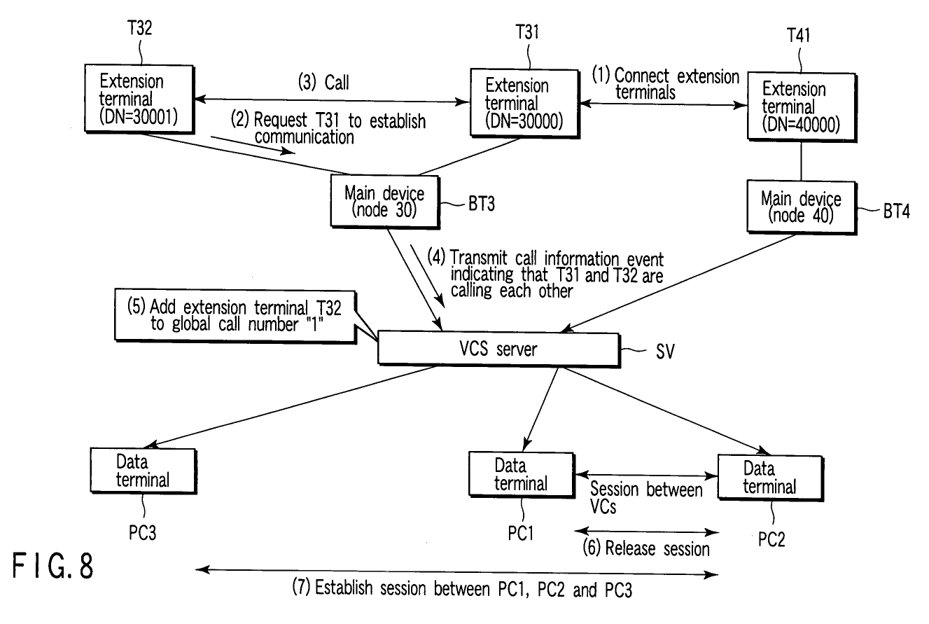

Assume now that the users of the extension terminals T31 and T41 are calling each other ((1) in FIG. 8).

Assume then that the user of the extension terminal T32 dials “30000” to call the user of the extension terminal T31. The extension terminal T32 transmits a communication establishment request signal to the main device BT3 ((2) in FIG. 8). Upon receiving the signal, the main device BT3 calls the extension terminal T31 while holding a communication link between the extension terminals T31 and T41. The extension terminal T31 replies to the main device BT3 and establishes a communication link with the extension terminal T32 ((3) in FIG. 8). Then, the extension terminal T31 supplies the VCS server SV with a call information event indicating that the users of the extension terminals T31 and T32 are calling each other ((4) in FIG. 8).

The VCS server SV receives the call information event and determines whether a global call number “1” included in the call information event is present in the table 131. Since it is present in this case, the VCS server SV moves from block ST7b to block ST7f to store in “connection 1” of the table 131 device information (DN, node ID) of the extension terminal T32 as well as the extension terminals T31 and T41 in correspondence with each other ((5) in FIG. 8). When the updating of the table 131 is completed, a session between the data terminals PC1 and PC2 is released ((6) in FIG. 8) and a session between the data terminals PC1, PC2 and PC3 is established ((7) in FIG. 8).

In the first embodiment described above, when a communication link is established between the extension terminals T31 and T41 in the VCS server SV, the device information (DN, node ID) of each of the extension terminals T31 and T41 included in a call information event supplied from the main device BT4, the global call number for identifying a call connection between the extension terminals T31 and T41, and the state information are stored in the table 131 in correspondence with each other. When the extension terminal T32 requests the extension terminal T31 in progress to call, the table 131 is referred to on the basis of the global call number included in a call information event supplied from the main device BT3 to update the corresponding state information in the table 131. Using the updated state information and the device information of each of the extension terminals T31, T32 and T41, a session is controlled between the data terminals PC1, PC2 and PC3 associated with their respective extension terminals T31, T32 and T41.

Consequently, even though a call information event not including other-end-device information during the execution of a call service in a multinode system, it is possible to specify which of the connections of the extension terminals T31 and T41 is changed on the basis of the global call numbers included in the call information event, referring to the table 131. Visual communication can thus be performed for each of the global call numbers to associate the extension terminals T31, T32 and T41 and the data terminals PC1, PC2 and PC3 with each other.

It can be considered that the amount of information included in the table 131 increases to pressure the storage unit 13 in the multinode system. The call numbers are integrated with the global call numbers, which are units for connection between the extension terminals, to make the device information (DN, node ID) and state information correspondent with each other. Thus, the capacity of the storage unit 13 can be reduced and the extension terminals T31 and T41 can quickly be specified from the global call numbers included in the call information event.

In the foregoing first embodiment, prior to the updating of state information in the table 131, the VCS server SV compares the global call numbers included in the call information event received from the main devices BT3 and BT4 and the global call numbers stored in the table 131 and determines whether the corresponding state information is updated or newly added on the basis of the comparison result. An appropriate state information updating process can thus be performed for each call state between the extension terminals T31 and T41.

### Second Embodiment

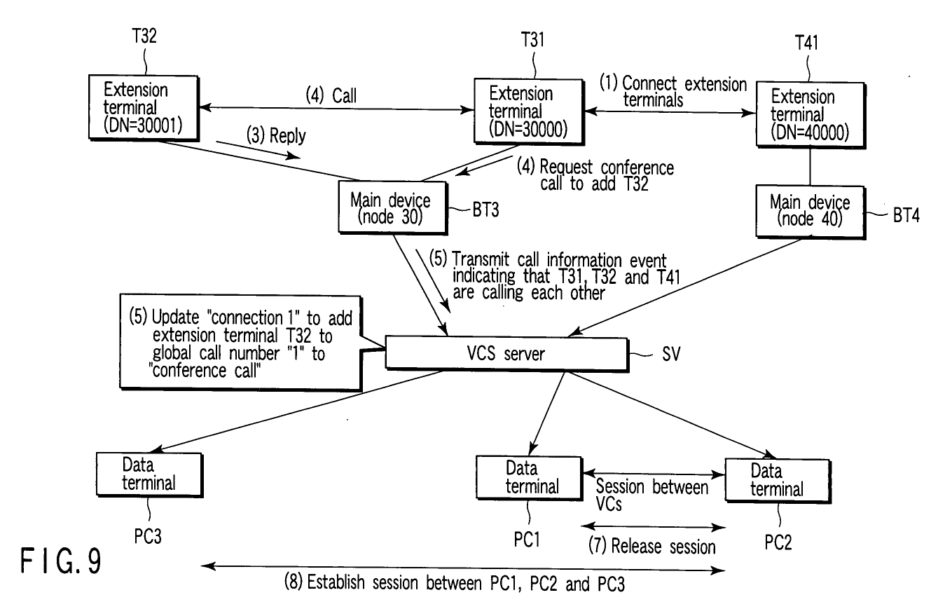

FIG. 9 is a sequence chart illustrating an operation of a conference call in which the extension terminal T32 is added to the extension terminals T31 and T41 in progress as a second embodiment of the present invention. In FIG. 9, the same components as those of FIG. 8 are denoted by the same reference numerals.

Assume that the user of the extension terminal T31 performs an operation to add the extension terminal T32 to a conference call. The extension terminal T31 transmits a request signal to the main device BT3 ((2) in FIG. 9). Upon receiving the request signal, the main device BT3 calls the extension terminal T32 while holding a communication link between the extension terminals T31 and T41.

If the user of the extension terminal T32 replies to the call, the extension terminal T32 transmits a response signal to the main device BT3 ((3) in FIG. 9).

Thus, the extension terminal T32 can be added to the conference call between the extension terminals T31 and T41 ((4) in FIG. 9). The main device BT3 detects that the conference is created and transmits the detection result to the VCS server SV as a call information event ((5) in FIG. 9).

Upon receiving the call information event, the VCS server SV determines whether a global call number “1” included in the call information event is present in the table 131. Since it is present here, the VCS server SV stores in “connection 1” of the table 131 the device information (DN, node ID) of the extension terminal T32 as well as the extension terminals T31 and T41 in correspondence with each other ((6) in FIG. 9). When the updating of the table 131 is completed, a session between the data terminals PC1 and PC2 is released ((7) in FIG. 9) and a session between the data terminals PC1, PC2 and PC3 is established ((8) in FIG. 9).

The second embodiment can thus provide the same advantage as that of the first embodiment.

### Other Embodiments

The present invention is not limited to the above embodiments. In the first and second embodiments, the main devices are connected to each other through a dedicated line. However, they can be connected to each other through a communication network other than the dedicated line.

The first and second embodiments are applied to a session established between the data terminals when a third party's interrupt call is made or when a conference call is made. However, the present invention can be applied to another call service.

Various modifications can be made to the configuration and type of the VCS server, the type of the telephone exchange (which is not limited to the main device but can be a PBX), the type of the internal terminals, the type of the data terminals, the contents stored in the tables, the method of controlling a session between the data terminals, and the like, without departing from the spirit or scope of the subject matter of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information including terminal IDs and connection IDs specifying a plurality of telephone terminals to perform call connections by a telephone exchange apparatus executing exchange processing among a plurality of telephone terminals, and which links data communication connections at data terminals associated with the plurality of the telephone terminals, respectively, with the call connections, the server apparatus comprising:
a memory which stores a management table indicating a correspondence relation between the terminal IDs and the connection IDs contained in a call information event from the telephone exchange apparatus and state information representing a call connection state between the plurality of telephone terminals, when the call connection is established between the plurality of telephone terminals;
a determination unit to determine whether a call connection state between telephone terminals corresponding to the connection IDs is changed by referring to the management table based on the connection IDs contained in the call information event, when the call information event is received; and
a controller which updates state information corresponding to the connection IDs in the management table, when the determination unit determines that the call connection state is changed, and performs a data communication connection between data terminals associated with the terminal IDs of the plurality of telephone terminals to be connected, based on the updated status information.

2. The server apparatus according to claim 1, when the controller receives a call information event about a connection request of a third telephone terminal to a first and second telephone terminals which have been placed in the call connected status,
wherein the controller updates the state information in the management table to state information indicating a call connection state between the first, second and third telephone terminals, and performs a data communication connection between first, second and third data terminals associated with terminal IDs of the first, second and third telephone terminals based on the updated state information.

3. The server apparatus according to claim 1, wherein the controller compares one of the connection IDs included in the call information event with connection IDs included in the management table and updates state information corresponding to the one of the connection IDs only when the one of the connection IDs coincides with one of the connection IDs included in the management table.
